(19) United States
(12) Patent Application Publication
(10) Pub. No.: US 2023/0197922 A1
(43) Pub. Date: Jun. 22, 2023

(54) COLD SPRAY DEPOSITION FOR ELECTRODE COATINGS

(71) Applicant: Applied Materials, Inc., Santa Clara, CA (US)

(72) Inventors: Sonal, Ames, IA (US); David Masayuki ISHIKAWA, Mountain View, CA (US); Sumedh Dattatraya ACHARYA, Bangalore (IN); Ezhiylmurugan RANGASAMY, San Jose, CA (US); Subramanya P. HERLE, Mountain View, CA (US)

(21) Appl. No.: 17/987,477

(22) Filed: Nov. 15, 2022

Related U.S. Application Data
(60) Provisional application No. 63/290,542, filed on Dec. 16, 2021.

(51) Int. Cl. H01M 4/04; H01M 10/0525; H01M 4/38; H01M 4/583

(52) U.S. Cl. CPC H01M 4/0419; H01M 4/38; H01M 4/583; H01M 10/0525; H01M 2004/027

(57) ABSTRACT

Embodiments of the present disclosure generally relate to electrode coatings and methods of coating electrodes. In an embodiment, a method of depositing a structure on a lithium ion battery (LIB) anode is provided. The method includes accelerating particles in a working gas through a convergent-divergent nozzle to a process velocity that is from a critical velocity of the particles to an erosion velocity of the LIB anode, the particles comprising a metal and/or a Group III-VI element; heating or cooling the particles in the working gas at a softening temperature; ejecting the particles in the working gas from a nozzle outlet of the convergent-divergent nozzle, the particles ejected at the process velocity, wherein at least a portion of the particles are in solid phase when ejected from the convergent-divergent nozzle; and depositing a first structure on the LIB anode, the first structure comprising the metal and/or the Group III-VI element.

### CROSS REFERENCES TO RELATED APPLICATIONS

This application claims benefit of and priority to U.S. Provisional Pat. Application Serial No. 63/290,542, filed on Dec. 16, 2021, which is incorporated herein by reference in its entirety.

### BACKGROUND

### Field

Embodiments of the present disclosure generally relate to electrode coatings and methods of coating electrodes.

### Description of the Related Art

Conventional methods for forming metal structures, such as metallic lithium reservoirs, on electrodes typically involve deposition at high temperatures that can cause deterioration of the anode and the current collector. For example, thermal evaporation and other physical vapor deposition methods can induce reservoir thermal stress (for example, current collector wrinkles) and can overheat alloy-type (for example, silicon) anodes and graphite anodes having low thermal budgets. Moreover, conventional web coating and vapor deposition methods produce poorly defined coated and uncoated edge transitions of the deposited material.

Another method for depositing metal structures on electrodes involves cold spraying of metal powder to form a reservoir with controlled thickness profile, composition, and morphology. In this cold spraying technique, metal powder is sprayed at high velocities to deposit metal structures without thermal stress and without overheating anodes with low thermal budgets. For example, Li metal powder is cold spray deposited on silicon-containing anode to manufacture high-capacity lithium ion batteries with long cycle life. Some metals powders are chemically reactive and therefore powder particle surface protection and activation methods or environmental controls are necessary to form electrochemically active reservoirs via cold spray. For example, stabilized lithium metal powder (SLMP) has a thin air-stable lithium carbonate surface protection layer, encapsulating a metallic lithium core, that is mechanically cracked on high velocity impact during cold spray deposition. Cold spray of SLMP, however, can suffer from electrochemically-inactive lithium carbonate contamination.

There is a need for new and improved methods of coating electrodes that overcomes one or more of the aforementioned deficiencies.

### SUMMARY

Embodiments of the present disclosure generally relate to electrode coatings and methods of coating electrodes.

In an embodiment, a method for depositing a structure on a lithium ion battery (LIB) anode is provided. The method includes accelerating particles in a working gas through a convergent-divergent nozzle to a process velocity that is from about a critical velocity of the particles to an erosion velocity of the LIB anode, the particles having a diameter of about 0.5 µm to about 50 µm, the particles comprising an alkali metal, a transition metal, a Group III element, a Group IV element, a Group V element, a Group VI element, or combinations thereof. The method further includes heating or cooling the particles in the working gas at a softening temperature concurrent with accelerating the particles; and ejecting the particles in the working gas from a nozzle outlet of the convergent-divergent nozzle, the particles ejected at the process velocity, wherein at least a portion of the particles are in solid phase when ejected from the convergent-divergent nozzle. The method further includes depositing a first structure on the LIB anode, the first structure comprising the alkali metal, the transition metal, the Group III element, the Group IV element, the Group V element, the Group VI element, or the combinations thereof. In some embodiments, the method further comprises repeating the accelerating, heating or cooling, and ejecting operations to deposit a second structure over at least a portion of the first structure, the second structure and the first structure comprising a different element of the periodic table of the elements. In at least one embodiment, substantially all of the particles ejected from the nozzle outlet are in the solid phase. In some embodiments, prior to accelerating the particles in the working gas, the method further comprises: introducing a flow of the working gas from a working gas inlet into a nozzle flow path of the convergent-divergent nozzle; and introducing the particles entrained in a carrier gas stream through a particle inlet into the flow of the working gas, the particle inlet located between the working gas inlet and a nozzle inlet of the convergent-divergent nozzle. In at least one embodiment, the LIB anode is oriented vertically in free-span or supported on a moveable substrate support. In some embodiments, the method further comprises: moving the LIB anode relative to the convergent-divergent nozzle during depositing the first structure when the LIB anode is supported on the moveable substrate support; moving the convergent-divergent nozzle relative to the LIB anode; or combinations thereof. In at least one embodiment, the first structure has: a thickness of about 0.5 µm to about 30 µm; an edge transition of about 3 mm or less; or combinations thereof. In some embodiments, wherein a mask is patterned on the anode prior to depositing the structure. In at least one embodiment, the LIB anode comprises graphite or an alloy comprising a Group IV element; the particles comprise Li, Na, Fe, Cu, Ag, Zn, Si, Ge, Sn, Bi, or combinations thereof; or combinations thereof. In some embodiments, the working gas comprises argon.

In another embodiment, a method of forming a solid metal anode is provided. The method includes introducing a flow of heated working gas from a working gas inlet into a nozzle flow path of a convergent-divergent nozzle; and injecting particles entrained in a carrier gas through a particle inlet into the flow of heated working gas, the particle inlet located between the working gas inlet and a nozzle inlet of the convergent-divergent nozzle, wherein: the particles have a diameter of about 0.5 µm to about 50 µm; and the particles comprise an alkali metal, a transition metal, a Group III element, a Group IV element, a Group V element, a Group VI element, or combinations thereof. The method further includes accelerating the particles in the flow of heated working gas through the convergent-divergent nozzle to a process velocity that is from about a critical velocity of the particles to an erosion velocity of a copper substrate of the solid metal anode; and ejecting the particles in the flow of heated working gas from a nozzle outlet of the convergent-divergent nozzle, the particles ejected at the process velocity, substantially all of the particles being in solid phase when ejected from the nozzle outlet. The method further includes depositing a first structure on the copper substrate to form the solid metal anode, the first structure comprising the alkali metal, the transition metal, the Group III element, the Group IV element, the Group V element, the Group VI element, or the combinations thereof. In some embodiments, the first structure is free of lithium. In at least one embodiment, the first structure comprises Ag, Si, Sn, or combinations thereof. In some embodiments, the first structure has: a thickness of about 0.5 µm to about 30 µm; an edge transition of about 3 mm or less; or combinations thereof. In at least one embodiment, the method further comprises repeating the introducing, injecting, accelerating, and ejecting operations to deposit a second structure over at least a portion of the first structure, the second structure comprising a different element of the periodic table of the elements than the first structure. In some embodiments, the second structure comprises Ag, Cu, Au, Zn or, combinations thereof. In at least one embodiment, the first structure comprises Li, Na, K, or combinations thereof; the first structure has a thickness of about 0.5 µm to about 30 µm; the second structure has a thickness of about 50 µm to about 200 µm; or combinations thereof.

In another embodiment, a method of forming an alkali metal-containing structure on an anode is provided. The method includes heating a working gas to a temperature near or below a melting point of an alkali metal; introducing a flow of heated working gas from a working gas inlet into a nozzle flow path of a convergent-divergent nozzle; and injecting alkali metal-containing particles entrained in a carrier gas through a particle inlet into the flow of the heated working gas, the particle inlet located between the working gas inlet and a nozzle inlet of the convergent-divergent nozzle, the alkali metal-containing particles having a diameter of less than about 50 µm. The method further includes accelerating the alkali metal-containing particles in the flow of heated working gas through the convergent-divergent nozzle to a process velocity that is from about a critical velocity of the alkali metal-containing particles to an erosion velocity of the anode; heating the alkali metal-containing particles in the flow of heated working gas at a softening temperature concurrent with accelerating the alkali metal-containing particles. The method further includes ejecting the alkali metal-containing particles in the heated working gas from a nozzle outlet of the convergent-divergent nozzle, the alkali metal-containing particles ejected at the process velocity, at least a portion of the alkali metal-containing particles being in solid phase when ejected from the convergent-divergent nozzle; and depositing the alkali metal-containing structure on the anode, the alkali metal-containing structure having a thickness of about 0.5 µm to about 30 µm. In some embodiments, the alkali metal comprises Li or Na. In at least one embodiment, the working gas comprises argon.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1 is a schematic diagram of an example cold spray apparatus according to at least one embodiment of the present disclosure.

FIG. 2 is a schematic diagram of various components of an example cold spray apparatus according to at least one embodiment of the present disclosure.

FIG. 3 is a flow chart showing selected operations of a method of depositing a structure on an electrode according to at least one embodiment of the present disclosure.

FIG. 4A is an illustration of an example pre-lithiation lithium reservoir on an anode formed utilizing embodiments described herein.

FIG. 4B is an illustration of an example pre-lithiation lithium reservoir on an anode formed utilizing embodiments described herein.

FIG. 5A is an illustration of an example lithium reservoir on an anode formed utilizing embodiments described herein.

FIG. 5B is an illustration of an example lithium metal-free reservoir on an anode formed utilizing embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to electrode coatings and methods of coating electrodes. The inventors have found new and improved methods and apparatus for coating electrodes, such as lithium ion battery (LIB) anodes among other electrodes. The inventors have also found new and improved methods for forming, for example, pre-lithiation lithium reservoirs, lithium reservoirs, and lithium metal-free reservoirs.

Briefly, and in some embodiments, apparatus described herein include a cold spray apparatus and a low-temperature deposition method of forming a structure, layer, coating, and/or film on an electrode. Such cold spray deposits are formed in the absence of the extreme deposition source temperatures and high condensation heat transfer generally used in thermal spraying and physical vapor deposition techniques. In this way, the formation of, for example, high-purity structures with compressive residual stresses on low thermal budget electrodes are enabled by embodiments described herein. As further described below, embodiments are not limited to lithium. Various metals and Group III-Group VI elements can be deposited utilizing methods and apparatus described herein. In some examples, embodiments described herein can be utilized to form, for example, 1 to 10 µm (or thicker) pre-lithiation reservoirs on temperature- and cost-sensitive LIB anodes. Moreover, embodiments described herein can be utilized for forming a variety of coatings on LIB anodes used for electric vehicles and consumer electronics.

State-of-the-art methods for forming metal layers on electrodes typically utilize deposition processes that cause mechanical damage to the electrodes. Such deposition methods used for, for example, pre-lithiation of anodes, are normally performed at temperatures that exceed the thermal budget of the materials of the anode substrate. For example, the anode can experience mechanical damage when a binder material present in the anode, such as poly(vinylidene fluoride) (PVDF), thermally decompose at temperatures above its thermal budget. In addition, the current collector can experience mechanical damage caused by thermal properties, for example, temperature dependent coefficient of thermal expansion, mismatch between the coatings, composites, and foil at temperatures exceeding thermal budgets of these different materials.

Various mechanisms that exceed the allowable thermal budget and adversely affect the materials deposited or the electrode substrate include condensation heat transfer due to thermal evaporation, exothermic chemical reactions between metals deposited (for example, lithium) and materials of the anode, and reservoir re-evaporation. With respect to pre-lithiation of anodes, thermal evaporation involves a phase change of the lithium (Li) from heated vapor to condensed solid. This phase change can increase the anode and current collector temperatures due to absorption of heat produced on the transformation from vaporized lithium to solid lithium. Metallic Li reservoir re-evaporation due to high radiation energy emitted by conventional deposition sources can also impact pre-lithiation uniformity by causing coatings to thin rather than build up in thickness during coating. Further, conventional pre-lithiation of metallic lithium reservoir structures can induce thermal or mechanical damage of the anode. For example, during electrolyte filling, the large surface area of stabilized lithium metal powders (SLMP) can engender higher rates of reaction, which may cause a rapid increase in anode temperature detrimental to the anode substrate and deposited materials. Moreover, from an operator perspective, metal powder handling, web coating, and mechanical calendaring can be eliminated using apparatus and methods described herein. For example, the metal particles can be formed in situ and deposited without hazardous air exposure.

Embodiments described herein overcome these and other challenges. In contrast to conventional techniques, embodiments described herein can avoid or substantially avoid damage to electrodes. For example, the deposition methods described herein can be performed at temperatures where the phase change of Li (or other metal or Group III-VI element) from vapor to solid is minimal or non-existent. Instead of the high temperature deposition, a cold spray technique is utilized to spray particles at high velocities onto an electrode substrate. The cold spray technique can enable formation of structures on the electrode substrate (or other substrate) at temperatures that avoid or minimize vapor-to-solid phase changes of the particles. Such low temperatures can also minimize radiation heat transfer and coating sublimation. Moreover, electrode wrinkling is minimized relative to conventional strategies for coating electrodes.

For purposes of the present disclosure, the terms “structure”, “coating”, “layer”, and “film” are used interchangeably such that reference to one includes reference to the others. For example, reference to “structure” includes structure, coating, layer, and film unless the context indicates otherwise. For purposes of the present disclosure, the terms “pre-lithiated” and “lithiated” are used interchangeably unless the context indicates otherwise, such that reference to “pre-lithiated” includes pre-lithiated and lithiated.

Embodiments of the present disclosure may also be described with respect to anodes. However, it is contemplated that the embodiments described herein can apply to electrodes generally, for example, both anodes and cathodes.

Embodiments of the present disclosure may also be described with depositing lithium and/or utilizing lithium-containing particles. However, embodiments described herein can be utilized with other particles to deposit other materials, including alkali metals, transition metals, Group III elements, Group IV elements, Group V elements, Group VI elements, an ion thereof, compositions comprising one or more of such elements (for example, oxides), alloys comprising such materials, and combinations thereof.

Examples of alkali metals of the periodic table of the elements useful with embodiments described herein include lithium (Li), sodium (Na), potassium (K), rubidium (Rb), cesium (Cs), an ion thereof, compositions comprising such elements (for example, oxides, nitrides, et cetera), or combinations thereof. For example, one or more methods of depositing a sodium-containing structure can be accomplished utilizing one or more embodiments of the present disclosure. Such sodium-containing structures can be a portion of a pre-sodiated anode (or sodiated anode) used in, for example, sodium ion batteries.

Illustrative, but non-limiting, examples of transition metals of the periodic table of the elements useful with embodiments described herein include copper (Cu), titanium (Ti), manganese (Mn), iron (Fe), silver (Ag), Ni (nickel), gold (Au), zinc (Zn), an ion thereof, compositions comprising such elements (for example, oxides), or combinations thereof, though other transition metals are contemplated. For example, an Ag-containing structure can be deposited on an anode according to some embodiments described herein. Ag and other metals can be cold sprayed onto anodes to, for example, minimize dendrites.

Illustrative, but non-limiting, examples of Group III elements of the periodic table of the elements useful with embodiments described herein include boron (B), aluminum (Al), gallium (Ga), indium (In), an ion thereof, compositions comprising such elements (for example, oxides), or combinations thereof. For example, an Al-containing structure can be deposited on an anode according to some embodiments described herein. Group III elements are also referred to as Group 13 elements of the periodic table of the elements.

Non-limiting examples of Group IV elements of the periodic table of the elements useful with embodiments described herein include carbon (C), silicon (Si), germanium (Ge), tin (Sn), an ion thereof, compositions comprising such elements (for example, oxides), or combinations thereof. For example, a Si-containing structure can be deposited on an anode according to some embodiments described herein. Group IV elements are also referred to Group 14 elements of the periodic table of the elements.

Illustrative, but non-limiting, examples of Group V elements of the periodic table of the elements useful with embodiments described herein include nitrogen (N), phosphorous (P), arsenic (As), antimony (Sb), bismuth (Bi), an ion thereof, compositions comprising such elements (for example, oxides), or combinations thereof. For example, a Sb-containing structure can be deposited on an anode according to some embodiments described herein. Group V elements are also referred to Group 15 elements of the periodic table of the elements.

Illustrative, but non-limiting, examples of Group VI elements of the periodic table of the elements useful with embodiments described herein include oxygen (O), sulfur (S), selenium (Se), tellurium (Te), an ion thereof, compositions comprising such elements (for example, oxides, sulfides), or combinations thereof. Group VI elements are also referred to Group 16 elements of the periodic table of the elements.

Compositions that include one or more of the aforementioned materials (for example, oxides, nitrides, and chalcogenides) can be utilized with embodiments described. For example, a Group IV-containing structure deposited on an anode can include silicon oxide. Combinations of one or more above materials are useful with embodiments described herein. For example, a germanium-tin alloy or a copper-tin alloy can be deposited utilizing embodiments described herein.

Particles comprising one or more of these aforementioned elements of the periodic table of the elements can be utilized with embodiments described herein. For example, particles can include an alkali metal, a transition metal, a Group III element, a Group IV element, a Group V element, a Group VI element, an ion thereof, compositions comprising one or more of such elements, et cetera), or combinations thereof.

The apparatus and methods described herein are useful for depositing materials on a variety of anodes such as anodes comprising graphite, an alloy, or a combination thereof. For purposes of the present disclosure, anodes comprising an alloy and alloy-type anodes refer to anodes comprising at least one Group III-Group VI element of the periodic table, for example, Al, Ga, In, C, Si, Ge, Sn, As, Sb, or Bi. Such alloys include at least one other element of the periodic table. The at least one other element can be a different Group III-Group VI element, or can be an element outside of Group III-Group VI. For example, the alloy of the anode (or an alloy-type anode) can include a silicon or SiOx composite with graphite, silicon-carbon alloy, silicon-aluminum alloy, a germanium-selenium alloy, a germanium-iron alloy, a germanium-tin alloy, copper-tin alloy, among many others. The alloy or alloy-type anode can be in the form of a composite material.

Embodiments of the present disclosure can be further understood by the following non-limiting examples. The following non-limiting examples are put forth so as to provide those of ordinary skill in the art with a complete disclosure and description of how to make and use aspects of the present disclosure, and are not intended to limit the scope of aspects of the present disclosure.

### Example Apparatus

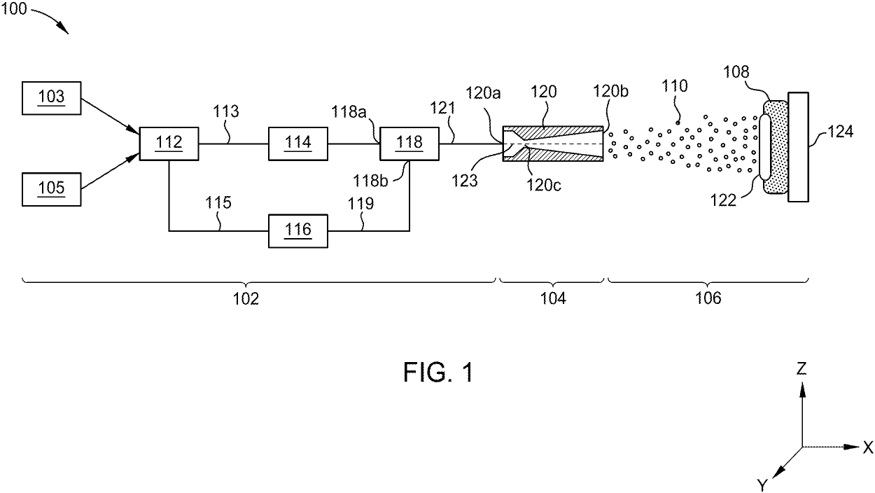

FIG. 1 is a schematic diagram of a cold spray apparatus 100 according to at least one embodiment of the present disclosure. The cold spray apparatus 100 includes a source region 102, a particle accelerating region 104, and a deposition region 106. The source region 102 is utilized to, for example, provide gas(es) and particles to the particle accelerating region 104. The particle accelerating region 104 accelerates the particles to a substrate 108 located in the deposition region 106. In the deposition region 106, the accelerated particles contact at least a portion of the substrate 108. The substrate 108 can be at least a portion of an anode such as a lithium-ion battery anode. In some examples, the substrate 108 can be a current collector, such as a copper web current collector. In some examples, the substrate 108 is a bowed plated or other web susceptor.

As further described below, the particle accelerating region is configured to spray or otherwise eject the particles onto the substrate 108. The particles, which are at a desired temperature and a desired velocity, impact with the substrate 108, to plastically deform and adhere those particles onto a surface of the substrate 108 where a deposited material 122 (for example, a structure) is formed. The particles can include an alkali metal, an ion thereof, a transition metal, an ion thereof, a Group III element, an ion thereof, a Group IV element, an ion thereof, a Group V element, an ion thereof, a Group VI element, an ion thereof, compounds including one or more of such elements, or combinations thereof.

The source region 102 includes a gas control module 112 in fluid communication with a heat exchanger 114 and a particle feeder 116 via line 113 and line 115, respectively. The gas control module 112 is utilized to provide a controlled, pressurized flow of a working gas 103 and a carrier gas 105 through various regions of the cold spray apparatus 100. The working gas 103 can include N₂, He, Ne, Ar, Kr, Xe, or combinations thereof, such as Ar. The carrier gas 105 can include N₂, He, Ne, Ar, Kr, Xe, or combinations thereof, such as N2, He, Ar, or combinations thereof. The working gas 103 and carrier gas 105 can enter the gas control module via an inlet (not shown).

In some embodiments, the working gas 103 is utilized to provide a pressurized and controlled flow of particles from the manifold 118 to the particle accelerating region 104. The carrier gas 105 can be utilized to carry particles from the particle feeder 116 to the manifold 118, in, for example, a pressurized and controlled manner. The heat exchanger 114 is utilized to heat or cool the working gas 103 to one or more desired temperatures. Such desired temperatures can include softening temperatures of a metal of the particle, a Group III-Group VI element of the particle, et cetera, as further described below.

The particle feeder 116 is configured to store or prepare the particles or powders thereof for use in the cold spray process. The particle feeder 116 can also be utilized to provide an in situ source of particles or powders thereof. In some examples, the particle feeder 116 is an atomizer.

The heat exchanger 114, through which the working gas 103 is flown, is in fluid communication with the manifold 118 via a working gas line 117. The particle feeder 116, through which particles are carried in a carrier gas 105, is in fluid communication with the manifold 118 via a particle line 119. The manifold 118 is in fluid communication with the nozzle 120 via line 121. The manifold 118 (for example, a particle injector) can be utilized to inject particles into a nozzle 120. In some embodiments, the apparatus may be free of a manifold. In such cases, and as further described below, particles in the carrier gas 105 can be injected into a flow path of the working gas 103 at a location between a working gas inlet and an inlet of the nozzle 120.

The nozzle 120 is configured to accelerate the particles to a desired velocity as described below. The nozzle 120 can be a convergent-divergent nozzle such as a de Laval nozzle. The nozzle 120 can be made of SiC or other suitable materials. The nozzle 120 has a nozzle flow path 123. The nozzle flow path 123 has a cross-sectional area that converges from the nozzle inlet 120a to a throat 120c and diverges from the throat 120c to a nozzle outlet 120b. The throat 120c has a smaller cross-sectional area than each of the nozzle inlet 120a and the nozzle outlet 120b due to the converging region extending from the nozzle inlet 120a to the throat 120c and the diverging region extending from the throat 120c to the nozzle outlet 120b.

The nozzle 120 is further configured to accelerate the particles to a desired supersonic velocity, further discussed below. In some examples, the nozzle is configured to shape and/or direct a plume of particles (for example, the particles entrained in the working gas) onto the substrate 108. Ejection of the particles at a desired temperature (for example, near a softening point) and/or at a desired velocity (for example, below, at, or near the critical velocity) impact with the substrate 108, to plastically deform and adhere those particles onto a surface of the substrate 108. The substrate 108 (for example, an electrode, an LIB anode, a current collector, or other suitable substrates described herein though other substrates are contemplated) can be positioned on a substrate support 124 as shown. The substrate 108 can be an electrode, an LIB anode, a current collector (such as a copper web current collector, copper foil, or other foil), or other substrates described herein. Other substrates are contemplated. The substrate support 124 can be a suitable element to mechanically support the substrate 108, such as a stationary or moveable substrate support, such as a rotating drum, a moveable plate, or rollers. Additionally, or alternatively, the substrate 108 can be oriented vertically in free-span. Here, a planar web of the substrate can move through the deposition region 106 on support rollers and the web can be kept under tension to keep it flat with respect to the deposition source. In some embodiments, the deposition can be a single side deposition per pass or a simultaneous double side deposition per pass.

A distance from the nozzle outlet 120b to a surface of the substrate 108 (for example, the surface to which the particles are deposited) can be about 100 mm or less, such as about 80 mm or less, such as about 60 mm or less, such as about 50 mm or less, 40 mm or less, such as about 35 mm or less, such as about 30 mm or less, such as about 25 mm or less, such as about 20 mm or less, such as about 15 mm or less, though other distances are contemplated.

In operation, and according to some embodiments, the pressurized carrier gas 105 carries particles from the particle feeder 116 to the manifold 118. The working gas 103 travels through the heat exchanger 114 to provide a heated or cooled working gas. The heated or cooled working gas is introduced with the stream of particles in the carrier gas 105 and the particles become entrained in the heated or cooled working gas. The heated or cooled working gas carries the particles from the manifold 118 to the nozzle 120. The particles entrained in the working gas are injected into the nozzle flow path 123 of the nozzle 120 via the nozzle inlet 120a, and carried through the converging region of the nozzle 120 (i.e., the region from the nozzle inlet 120a to the throat 120c of the nozzle 120). The particles entrained in the working gas are then carried through the diverging region of the nozzle 120 (i.e., the region from the throat 120c to the nozzle outlet 120b). The particles are then ejected from the nozzle 120 via the nozzle outlet 120b and deposited onto the substrate 108. Here, a stream of particles, shown as numeral 110, contact one or more faces of the substrate 108 to form a deposited material 122. The deposited material 122 can be a structure containing a metal and/or a Group III-Group VI element of the particles. The deposited material may be a composite material or an alloy.

As discussed above, the working gas 103 is heated or cooled to a desired temperature by the heat exchanger 114. The desired temperature can be a temperature below, at, and/or near a softening point and/or melting point of the metal or Group III-Group VI element of the particles. That is, when the particles are ejected from the nozzle 120, at least a portion (such as all or substantially all) of the particles are below, at, and/or near a softening point and/or melting point of the metal or Group III-Group VI element. In such cases, the at least a portion (such as all or substantially all) of the particles are in the solid phase when ejected from the nozzle 120.

In some examples, the nozzle 120 is configured to move in the z-direction such that the particles are deposited onto the substrate 108 in a single pass or multiple passes. For example, the particles can be ejected while the nozzle 120 moves along a face of the substrate 108 at a desired rate. Movement of the nozzle 120 can be caused by, for example, a robotic arm. Additionally, or alternatively, the substrate support 124 can be configured to move in the z-direction. Movement of the substrate support 124 in the z-direction causes movement of the substrate 108 along a face of the nozzle outlet 120b and enables, for example, deposition of the metal and/or Group III-Group VI element onto the substrate 108 in a single pass or multiple passes. For example, the particles can be ejected while the substrate support 124 moves along a face of the nozzle outlet 120b at a desired deposition rate. In some examples, one or both of the nozzle 120 and/or the substrate support 124 can be configured to move. Movement of the nozzle 120 and the substrate support 124 can be performed at the same time or different times of the deposition process.

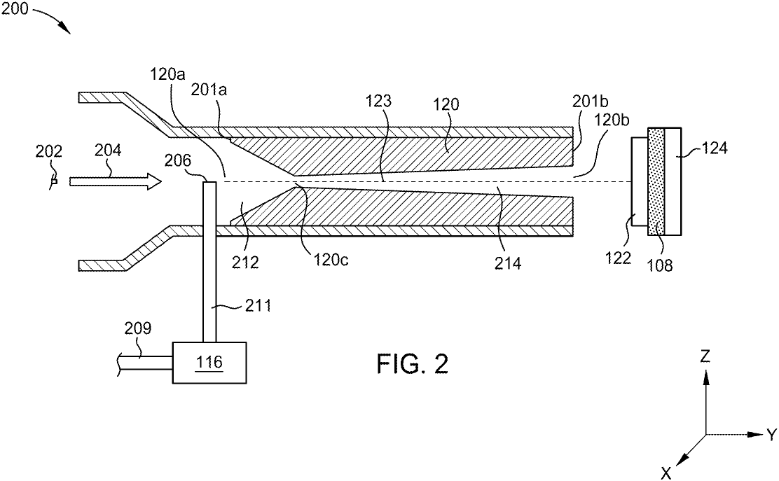

Embodiments of the cold-spray apparatus can be utilized with embodiments described with respect to FIG. 2.

FIG. 2 is a schematic diagram of a portion of a cold spray apparatus 200 according to at least one embodiment of the present disclosure. The cold spray apparatus 200 shown in FIG. 2 is an illustrative, non-limiting, embodiment. One or more embodiments of FIG. 2 can be utilized with the apparatus shown in FIG. 1, and vice-versa.

In the arrangement shown in FIG. 2, the nozzle 120 is a convergent-divergent nozzle or a de Laval nozzle. The nozzle 120 has a nozzle inlet 120a located at or near a first end 201a of the nozzle 120 and a nozzle outlet 120b located at or near a second end 201b of the nozzle 120. The nozzle also has a converging region 212 located between the first end 201a of the nozzle 120 and a throat 120c. The nozzle 120 also has a diverging region 214 located between the throat 120c and the second end 201b of the nozzle 120. The nozzle 120 has a nozzle flow path 123 along the length of the nozzle 120. The nozzle flow path 123 has a cross-sectional shape that converges from the first end 201a of the nozzle 120 to the throat 120c and diverges from the throat 120c to the second end 201b of the nozzle 120. The nozzle 120 can be made of SiC or other suitable materials. The throat 120c has a cross-sectional area that is smaller than the cross-sectional area of the converging region 212 and the diverging region 214. The throat 120c has a narrower shape than a shape of the first end 201a and the second end 201b. The nozzle 120 is generally configured to accelerate particles to a desired velocity.

A flow path 204 is located in fluid communication with the nozzle flow path 123. The nozzle flow path 123 can be parallel or substantially parallel to the flow path 204. A working gas (for example, working gas 103) enters the flow path 204 via a working gas inlet 202. The working gas inlet 202 is in fluid communication with the converging region 212 of the nozzle 120 such that the working gas 103 flows into the nozzle flow path 123. The working gas 103 is in fluid communication with a heat exchanger (not shown) to heat or cool the working gas 103 and a gas control module (not shown) to pressurize the working gas 103. Suitable working gases are described above.

A particle feeder 116 is configured to store or prepare the particles or powders thereof for use in the cold spray process. The particle feeder 116 can also be utilized to provide an in situ source of particles or powders thereof. The particles or a powder thereof can include, for example, the metal(s) and/or Group III-Group VI element(s), among other materials, described above. In some examples, the particle feeder 116 is an atomizer. The particle feeder 116 is in fluid communication with the flow path 204 via line 211 and a particle inlet 206. The particle feeder 116 is in fluid communication with a carrier gas line 209, such that a carrier gas (for example, carrier gas 105) can be flown into the particle feeder 116 and introduced with particles or powders thereof. The carrier gas 105 entrains the particles and carries the particles into the flow path 204 via the particle inlet 206.

The particle inlet 206 is located along the flow path 204 before the first end 201a of the nozzle. The particle inlet 206 is also located between the working gas inlet 202 and the nozzle inlet 120a. As shown, the particle inlet 206 is transverse to the flow path 204 and transverse to the nozzle flow path 123. The particle inlet 206 is configured to flow or inject a stream of particles in a carrier gas 105 into the flow path 204. Suitable carrier gases are described above.

The particle inlet 206 has a particle flow path that intersects the flow path 204. Here, the particles in the carrier gas 105 can be fed into the flow path 204 at an angle other than 0°, such as from about 1° to about 90° to the flow path of the working gas 103 that travels down the nozzle 120. Although a single particle inlet 206 is shown, a plurality of particle inlets can be utilized for, for example, feeding one or more different types of particles to the flow path 204.

The substrate 108 (for example, an electrode, an LIB anode, a current collector, or other suitable substrates described herein though other substrates are contemplated) can be positioned on a substrate support 124 as shown. The substrate 108 can be an electrode, an LIB anode, a current collector (such as a copper web current collector, copper foil, or other foil), or other substrates described herein. Other substrates are contemplated. The substrate support 124 can be a suitable element to mechanically support the substrate 108, such as a stationary or moveable substrate support, such as a rotating drum, a moveable plate, or rollers. Additionally, or alternatively, the substrate 108 can be oriented vertically in free-span, as described above.

A distance from the nozzle outlet 120b to a surface of the substrate 108 (for example, the surface to which the particles are deposited) can be about 100 mm or less, such as about 80 mm or less, such as about 60 mm or less, such as about 50 mm or less, 40 mm or less, such as about 35 mm or less, such as about 30 mm or less, such as about 25 mm or less, such as about 20 mm or less, such as about 15 mm or less, though other distances are contemplated.

In operation, a flow of pressurized working gas (for example, working gas 103, which can be heated or cooled) enters the nozzle flow path 123 via a working gas inlet 202 and the flow path 204. A flow of pressurized carrier gas (for example, carrier gas 105) is flown to the particle feeder 116, where it is introduced to particles. The carrier gas entrains the particles. The particles entrained in the carrier gas stream are introduced to the flow of the working gas via particle inlet 206 where the particles become entrained with the working gas. The particles entrained in the working gas enter the nozzle flow path 123 of the nozzle via the nozzle inlet 120a. The particles entrained in the working gas are carried through the converging region 212 of the nozzle 120, through the throat 120c, and then through the diverging region 214 of the nozzle 120. The particles are then ejected from the nozzle 120 via the nozzle outlet 120b and deposited onto the substrate 108 disposed on a substrate support 124 or oriented vertically in free-span as described above. Here, a stream of particles contact one or more faces of the substrate 108 to form a deposited material 122. The stream of particles ejected is at a desired velocity and a desired temperature as further described herein. The deposited material 122 can be a coating, a layer, and/or a structure containing a metal and/or Group III-Group VI element of the particles, among other materials described herein. The deposited material 122 may be a composite material or an alloy. The substrate 108 can be an anode such as those described herein (for example, an LIB anode, such as a copper-containing anode) and/or a current collector (such as a copper web current collector, copper foil, or other foil), though other substrates are contemplated.

In some examples, the particle feeder 116 can be configured to permit the flow of a plurality of different particles, for example, first particles comprising a transition metal (for example, Ag) and second particles comprising a Group IV element (for example, Sn or Si). The plurality of different particles can enter the flow path 204 from the same particle inlet (for example, particle inlet 206) or different particle inlets. In this way, multiple materials can be deposited concurrently and/or sequentially. For example, first particles comprising a transition metal (for example, Ag) and second particles comprising a Group IV element (for example, Sn or Si) can be deposited on the substrate 108 concurrently and/or sequentially. A first structure comprising a first element can be deposited utilizing the first particles, and then a second structure comprising a second element can be deposited on at least a portion of the first structure, deposited on a different surface of the substrate, deposited on a different substrate, et cetera.

Embodiments and implementations of FIG. 1 can be utilized with FIG. 2, and vice-versa. For example, substrate support 124 can be utilized to move the substrate for desirable coating profiles and/or thicknesses of the deposited material 122. As another example, the nozzle 120 can be caused to move along a face of the substrate for desirable coating profiles and/or thicknesses of the deposited material 122.

Use of the cold spray apparatus 100 and/or cold spray apparatus 200 with operations of the methods described herein can enable deposition of a variety of metals and/or Group III-Group VI elements. The deposition methods, further described below, can be performed for suitable durations to achieve, for example, a desired coating thickness coating profile of the deposited material 122, and/or controlled transitions between coated and uncoated areas of the substrate 108. If desired, the coating profile, among other characteristics of the deposited material 122, can be controlled by use of a mask, though a mask is optional.

### Example Methods

Embodiments of the present disclosure also relate to methods for depositing structures (or coatings) on at least a portion of a substrate, such as an electrode, an anode, LIB anode, current collector, and foil. Such structures deposited can include those described herein, for example, alkali metal(s), transition metal(s), Group III-Group VI element(s), mixtures thereof, oxides thereof, combinations thereof, among others. Embodiments of the methods can be utilized for, for example, pre-lithiation such as pre-lithiation of LIB anodes, forming anodes such as solid metal anodes, depositing lithium reservoirs to form lithium metal anodes, and for forming lithium metal free-anodes using a variety of other metals, Group III-Group VI elements, and functional coating. The methods generally utilize one or more embodiments of the cold spray apparatus and equipment shown in FIG. 1 and/or 2, though the methods are not limited to such operations.

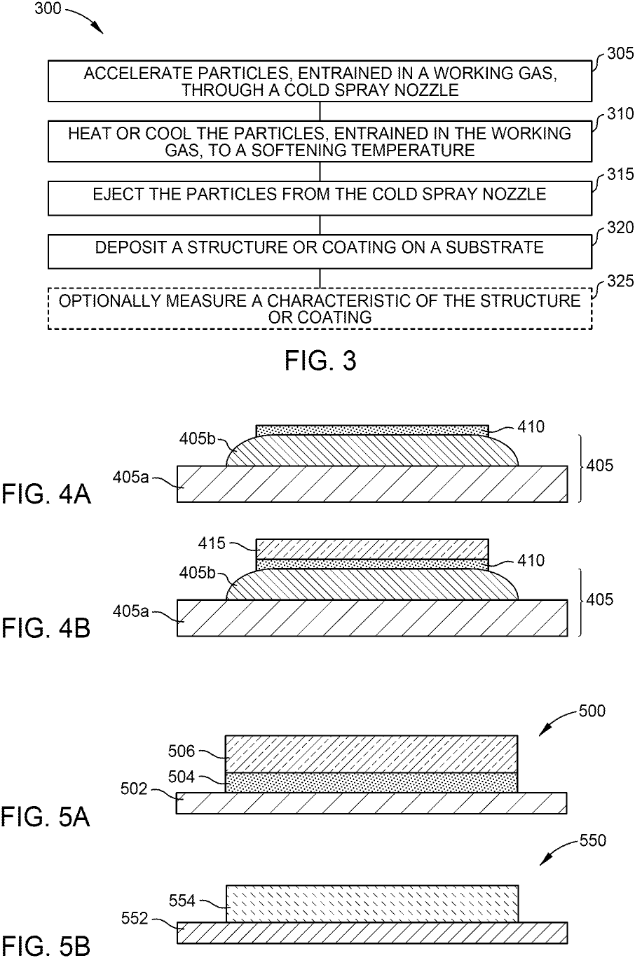

FIG. 3 is a flowchart showing example operations of a method 300 for depositing a structure on an electrode. As described above, the structure can be a coating, a film, a layer, or other suitable structure that includes a metal, a Group III-Group VI element, compositions containing such elements (for example, oxides), alloys comprising such materials, and combinations thereof, among others. By, for example, choice of the metal, the method can be utilized for forming solid metal anodes such as lithium anodes and lithium metal-free anodes. Moreover, the methods can be used for a variety of anodes such as electric vehicle LIB anodes and consumer electric anodes.

The method 300 begins with accelerating particles through a cold spray nozzle (for example, nozzle 120) at operation 305. A diameter of the particles can be less than about 50 µm in diameter, such as from about 0.5 µm to about 50 µm, such as from about 1 µm to about 25 µm, such as from about 5 µm to about 15 µm. In at least one embodiment, the diameter of the particles can be about 10 µm or less, such as from about 0.5 µm to about 5 µm, such as from about 1 µm to about 3 µm, though a larger or smaller diameter of the particles are contemplated. In some embodiments, the diameter of the particles is from about 5 µm to about 50 µm. The particles can be generated in situ and/or obtained commercially depending on, for example, the metal and/or Group III-Group VI element of the particles. For example, particles comprising Li may be moisture unstable, so it may be desired to form particles comprising Li in situ. Moreover, equipment can be utilized to, for example, transform an alkali metal salt to its constituent parts, for example, the alkali metal(s) and the counterion(s). The alkali metals of the salt can be utilized as particles, while the counterion(s) the salt can be substantially removed from the apparatus or otherwise substantially impeded from deposition operations. As another example, a transition metal complex/compound can be transformed to its constituent parts, for example, the transition metal and the counter ion(s). In some embodiments, particles or powders such as SLMP®, can be utilized as a lithium source. In at least one embodiment, particles or powders of various materials can be produced in-situ from bulk materials and the particles/powders can be sorted based on size if desired.

During operation 305, the particles are accelerated to a velocity that is below, at, and/or near a critical velocity of the particle. The critical velocity can depend on the composition of the particles. That is, the critical velocity can depend on whether the particles include a metal, a Group III-Group VI element, an ion thereof, combinations thereof, et cetera. A velocity that is at or near the critical velocity allows for, for example, a firm bond between the deposited material (for example, the coating/structure) and the substrate 108. If the particle velocity is too high, there can be deformation between the deposited material 122 and the substrate 108, for example, erosion of the substrate. The velocity at which the substrate 108 is eroded is referred to as the erosion velocity.

In some examples, the velocity of the particles is below, at, or near the critical velocity of the particles. In some examples, the velocity of the particles is in between the critical velocity of the particles and the erosion velocity. In some embodiments, the velocity of the particles is from about 75% lower than the critical velocity to about 30% higher than the critical velocity, such as from about 50% lower than the critical velocity to about 20% higher than the critical velocity, such as from about 25% lower than the critical velocity to about 10% higher than the critical velocity. In at least one example, the velocity of the particles is from about 340 meters per second (m/s) to about 650 m/s, such as from about 400 m/s to about 600 m/s, such as from about 450 m/s to about 550 m/s, though higher or lower velocities are contemplated.

The method 300 further includes heating or cooling the particles in the gas stream (for example, the working gas 103) to a softening temperature at operation 310. The softening temperature is a temperature that is below, at, or near a melting point of the component/material of the particle that is to be deposited (for example, the metal of the particle, the Group III-Group VI element of the particle, et cetera). Operation 310 can be performed concurrently with accelerating the particles. Operation 310 can be performed by operating the heat exchanger 114 at a desired temperature that softens the component of the particles that is to be deposited

In some examples, the process of operation 310 includes heating or cooling the gas stream (for example, the working gas 103) at a temperature that can be from about 60% lower than the melting point (MP) of the metal or Group III-VI element to about 40% higher than the MP of the metal or Group III-VI element, such as from about 50% lower than the MP to about 30% higher than the MP, such as from about 40% lower than the MP to about 20% higher than the MP, such as from about 30% lower than the MP to about 15% higher than the MP, such as from about 20% lower than the MP to about 10% higher than the MP, such as from about 15% lower than the MP to about 10% higher than the MP, such as from about 10% lower than the MP to about 10% higher than the MP, such as from about 5% lower than the MP to about 5% higher than the MP, though higher or lower melting points are contemplated. Heating or cooling the gas stream affects the phase of the particles in the gas stream. In some embodiments, all or substantially all of the particles are in the solid phase when exiting the nozzle 120.

As an example, Li has a melting point of about 180° C. Here, the gas stream (for example, the working gas 103) in which Li-containing particles are entrained can be heated at a temperature of about 160° C. to about 185° C., such as from about 165° C. to about 175° C., though higher or lower temperatures are contemplated. As another example, Ag has a melting point of about 961° C. Here, the gas stream (for example, the working gas 103) in which Ag-containing particles are entrained can be heated at a temperature of about 900° C. to about 980° C., such as from about 920° C. to about 970° C., such as from about 940° C. to about 960° C., though higher or lower temperatures are contemplated. As another example, Si has a melting point of about 1410° C. Here, the gas stream (for example, the working gas 103) in which Si-containing particles are entrained can be heated at a temperature of about 1300° C. to about 1450° C., such as from about 1350° C. to about 1425° C., such as from about 1375° C. to about 1420° C., though higher or lower temperatures are contemplated.

The method 300 further includes ejecting the particles (or gas stream of particles) from the nozzle at operation 315. The particles are ejected at a desired velocity. The particles are also at a desired temperature based on the temperature at which the working gas 103 is operated. The ejection process of operation 315 can include shaping and/or directing a plume of the particles entrained in the working gas to the substrate 108 (for example, anode, current collector, foil, et cetera). As described above, the substrate 108 can be oriented vertically in free-span or can be mechanically supported on the substrate support 124, such as a stationary or moveable support, such as a rotating drum, a moveable plate, or rollers.

The method 300 further includes depositing a structure on at least a portion of the substrate 108 at operation 320. During deposition, the pressure can be from about 0.5 atm to about 2 atm, such as from about 0.8 atm to about 1.2 atm, such as from about 0.9 atm to about 1.1 atm, such as about 1 atm.

The structure (for example, the deposited material 122) can have various characteristics such as a thickness, an edge transition (thickness progression), a Ra value, a Rz value, a density, and a coating profile, among other properties. These and other properties of the deposited material 122 are further described below. The deposition at operation 320 can continue until for example, a desired characteristic is achieved, for example, a desired thickness and/or a desired coating profile. In some examples, operation 320 results in a coating on the substrate, for example, a pre-lithiation lithium reservoir on the anode, a pre-sodiation sodium reservoir on the anode, et cetera. As described herein, the deposited material can include a variety of alkali metal(s), transition metal(s), and/or Group III-VI element(s), among others, and not just limited to Li and Na.

Optionally, method 300 can include moving the nozzle 120 and/or the substrate 108 by a single pass or a plurality of passes during one or more operations of the method 300, for example, operation 315 and/or operation 320. The number of passes can be chosen based on a desired characteristic of the deposited material such as a thickness or coating profile. The substrate can be moved by utilizing the moveable substrate support. The nozzle can be moved by, for example, a robotic arm.

In some embodiments, a magnetic field and/or an electric field can be utilized with the cold spray apparatus (for example, cold spray apparatus 100 or cold spray apparatus 200). The magnetic field and/or an electric field can be utilized to align the particles toward the substrate 108 to, for example, improve directionality, deposition efficiency, among other variables. The amount of magnetic and/or electric field depends on the magnetic and/or electrostatic properties of the particles. For example, the negative terminal of a high voltage (for example 1.25 kV) direct current power supply can be connected to the nozzle 120 and the substrate 108 connected to ground to bias the stream of particles 110 with electrostatic charge that minimizes parasitic deposition.

If desired, a mask can be used to, for example, control a deposition location, a transition between coated and uncoated areas, et cetera. Here, the mask can be patterned on the anode prior to depositing the structure, coating, or layer. The deposition can be performed without a mask.

One or more operations of the method 300, or embodiments of the methods 300 can be performed to, for example, deposit a structure on top of the deposited material 122. Any number of iterations are contemplated. Such additional structures deposited can include protection layers and alloying layers, among others. These structures are described below.

One or more types of particles can be used sequentially or concurrently and be flown through the same particle inlet or a different particle inlet. In such embodiments, multiple materials can be deposited concurrently or sequentially. For example, first particles comprising a transition metal (for example, Ag) and second particles comprising a Group IV element (for example, Si or Ge) can be deposited on the substrate 108 concurrently and/or sequentially. In these and other embodiments, the method 300 can include depositing a second structure on the first structure (for example, deposited material 122) via the same or similar process that the first structure is formed (for example, operations 305-320). This second structure formed on the can be utilized as a protection layer further discussed below. The protection layer can be deposited until, for example, a desired characteristic is achieved such as a thickness.

Method 300 can optionally include measuring a characteristic of the structure, coating, or layer formed (for example, the deposited material 122) at optional operation 325. In some examples, if it is desired to alter the characteristic (for example, thickness), additional material can be added using one or more operations of method 300.

The deposited material 122, which may be the first structure, the second structure, and so forth, can have one or more of the following characteristics:

(a) The deposited material 122 can have a thickness that is about 0.5 µm or more and/or about 30 µm or less, such as from about 1 µm to about 20 µm, such as from about 3 µm to about 15 µm, such as from about 5 µm to about 10 µm. In at least one embodiment, the deposited material 122 can have a thickness of about 10 µm or less, such as about 9 µm or less, such as about 8 µm or less, such as about 7 µm or less, such as about 6 µm or less, such as about 5 µm or less, such as about 4 µm or less, such as about 3 µm or less, such as about 2 µm or less, such as about 1 µm. In some examples, a thickness of the deposited material 122 can be greater than about 50 µm, such as from about 50 µm to about 200 µm, such as from about 50 µm to about 100 µm. A larger or smaller thickness is contemplated.

(b) The deposited material 122 can have an edge transition (thickness progression) that is about 3 mm or less, such as about 2 mm or less, such as about 1 mm or less, such as about 0.5 mm or less, though a larger or smaller edge transition is contemplated. The edge transition (thickness transition) refers to the width of the coating to reach 90% of the thickness from deposition edge. The edge transition is measured by scanning (Keyence 3D laser scanning microscope) the coated and uncoated regions to determine the step profile.

(c) The deposited material 122 can have an Ra value that is about 30% or less versus average film thickness, such as about 20% or less, such as about 10% or less, though other Ra values are contemplated. The Ra value refers to the average of the individual variance of the peaks and valleys of a surface. The Ra value is measured with a Keyence 3D laser scanning microscope.

(d) The deposited material 122 can have an Rz value that is about 100 % or less vs average film thickness, such as about 80% or less, such as about 60% or less, though other Rz values are contemplated. The Rz value refers to the largest difference from peak-to-valley of a surface. The Ra value can be determined by the following procedure The Rz value is measured with a Keyence 3D laser scanning microscope.

(e) The deposited material 122 can have a density that is greater than about 95%, such as greater than about 98%, such as greater than about 99%, though larger or smaller densities are contemplated. The density refers to the presence of voids or contaminants formed during cold spray that causes the deposited material 122 to deviate away from the theoretical maximum density (for example, 0.534 grams per cubic centimeter for lithium). The density can be determined by a Micromeritics Helium pycnometer.

Relative to thermal evaporation techniques, embodiments described herein can, for example, enable formation of electrodes having lower reservoir stress. Lower exothermic heat evolution can also be achieved by embodiments described herein. The lower reservoir stress and lower exothermic heat evolution minimizes the amount of wrinkles present in resulting anode structure after coating. Use of the methods described herein can also have a lower risk of electrode damage, due to, for example, the coating being formed below binder decomposition temperatures. Further, relative to thermal evaporation processes, the deposition methods described herein can be performed without a mask, while the apparatus described herein can be free of evaporators and drums typically used for toll coating. Further, embodiments described herein can be performed at about atmospheric pressures instead of costly vacuum processes.

As described above, SLMP powders are composite of Li and an organic shell (for example, a carbonate shell). This carbonate shell can affect the purity of the deposited material. In contrast, embodiments described herein can enable formation of structures having lower contaminants. However, SLMP powders can be utilized with embodiments described herein. Moreover, embodiments described herein are not limited to only lithium deposition, but can be utilized to deposit lithium, other alkali metals, transition metals, Group III-Group VI elements, compositions comprising such elements (for example, oxides), alloys comprising such materials, and combinations thereof. Further, embodiments described herein enable deposition with minimized electrode contact. The minimized electrode contact is enabled by, for example, utilizing nozzle velocity rather than calendaring (pressing) operation and other direct contact methods. Embodiments also enable thin coatings (for example, 0.5 µm to about 20 µm) as well as thick coatings (for example, >20 um) with improved yield by, for example, minimizing thermal damage.

### Example Uses of the Methods

The method 300 can be useful for pre-lithiation of electric vehicle (EV) LIB anodes, though other anodes are contemplated. Specifically, the method can be used for forming a pre-lithiation reservoir on various anodes such as graphite anodes and alloy-type anodes. FIGS. 4A and 4B illustrate embodiments of such coatings or structures, however the method is not limited to lithium

Specifically, FIG. 4A is an illustration of a pre-lithiation lithium reservoir 410 on a substrate 405. The substrate 405 (for example, substrate 108) can include a current collector 405a (for example, a copper web) and an anode 405b disposed over at least a portion of the current collector 405a. A thickness of the current collector 405a can be about 2 µm or more and/or about 30 µm or less, such as from about 6 µm to about 20 µm, such as from about 10 µm to about 15 µm, though other thicknesses are contemplated. The anode 405b can have a thickness of about 10 µm to about 200 µm, such as from about 30 µm to about 100 µm, such as from about 15 µm to about 60 µm, though a larger or smaller thickness of the anode 405b is contemplated. The anode can be a graphite-type or alloy-type anode, though other anodes are contemplated.

The pre-lithiation lithium reservoir 410 (for example, deposited material 122) is disposed over at least a portion of the anode 405b. The pre-lithiation lithium reservoir can be formed by one or more operations of method 300. As described above, control over the edges and/or other characteristics of the pre-lithiation lithium reservoir 410 can be performed utilizing a mask (such as an edge mask), though the mask is optional. Control over the edges and/or other characteristics the pre-lithiation lithium reservoir 410 can additionally, or alternatively, be performed by movement of the nozzle of the cold spray apparatus and/or movement of the substrate, among other techniques. Characteristics of the pre-lithiation lithium reservoir 410 can include one or more of those characteristics described above for the deposited material 122. In an illustrative, but non-limiting embodiment, a thickness of the pre-lithiation lithium reservoir 410 is from about 0.5 µm to about 30 µm, such as from about 1 µm to about 25 µm, such as from about 1 µm to about 20 µm, such as from about 5 µm to about 15 µm, such as from about 5 µm to about 10 µm or from about 10 µm to about 15 µm, though a larger or smaller thickness is contemplated.

FIG. 4B is an illustration of a pre-lithiation lithium reservoir 410 on a substrate 405. Embodiments of the substrate 405, current collector 405a, anode 405b, and the pre-lithiation lithium reservoir 410 are described above with respect to FIG. 4A. The embodiment shown in FIG. 4B includes a protection layer 415 disposed over at least a portion of the pre-lithiation lithium reservoir 410. The protection layer 415 can be formed by one or more operations of method 300. The protection layer 415 can be an alloying layer. Like the pre-lithiation lithium reservoir 410, the protection layer 415 can be formed with or without a mask. Control over the edges and/or other characteristics of the protection layer 415 be accomplished by similar methods discussed for the pre-lithiation lithium reservoir 410. Characteristics of the protection layer 415 can include one or more of those characteristics described above for the deposited material 122.

The protection layer 415 can be formed from one or more transition metals such as Ag, Cu, Au, and/or Zn, among others, such as those transition metals described herein. The protection layer 415 can have a thickness of about 10 nm to about 200 nm, such as from about 20 nm to about 100 nm, such as from about 30 nm to about 50 nm, though a larger or smaller thickness of the protection layer 415 is contemplated. In some examples, the thickness of the protection layer is less than about 20 nm, such as from about 10 nm to about 20 nm.

One or more operations of the method 300 can be utilized to form one or more structures, layers, or coatings on a consumer electronic (CE) solid metal anode, though other anodes are contemplated. For example, method 300 can be utilized for forming lithium reservoirs or lithium-free (for example, nanostructured high surface area silicon or silicon oxide) reservoirs on CE anodes. FIGS. 5A and 5B illustrate such embodiments.

Specifically, FIG. 5A illustrates an embodiment of a lithium metal anode 600. The lithium metal anode 500 includes a lithium reservoir 504 (for example, deposited material 122) disposed over at least a portion of a substrate 502. The substrate 502 (for example, substrate 108) can be a current collector, such as a copper web current collector. A thickness of the substrate 502 can be about 2 µm or more and/or about 30 µm or less, such as from about 6 µm to about 20 µm, such as from about 10 µm to about 15 µm, though other thicknesses are contemplated.

The lithium reservoir 504 can serve as a solid metal anode. The lithium reservoir 504 can be formed by one or more operations of method 300. Characteristics of the lithium reservoir 504 can include one or more of those characteristics described above for the deposited material 122. In an illustrative, but non-limiting embodiment, a thickness of the lithium reservoir 504 is from about 0.5 µm to about 30 µm, such as from about 1 µm to about 25 µm, such as from about 1 µm to about 20 µm, such as from about 5 µm to about 15 µm, such as from about 5 µm to about 10 µm or from about 10 µm to about 15 µm, though a larger or smaller thickness is contemplated.

In some embodiments, a protection layer 506 can be disposed over at least a portion of the lithium reservoir 504. The protection layer 506 can be formed by one or more operations of method 300. The protection layer 506 can be an alloying layer. The protection layer 506 include one or more transition metals such as Ag, Cu, Au, and/or Zn, among others, among others, such as those transition metals described herein. The protection layer 506 can have a thickness of about 5 nm to about 200 nm, such as from about 10 nm to about 100 nm, such as from about 15 nm to about 50 nm, though a larger or smaller thickness of the protection layer 506 is contemplated. Characteristics of the protection layer 506 can include one or more of those characteristics described above for the deposited material 122.

Like the lithium reservoir 504, the protection layer 506 can be formed with or without a mask. Control over the edges and/or other characteristics of the protection layer 506 can additionally, or alternatively, be performed by movement of the nozzle of the cold spray apparatus and/or movement of the substrate, among other techniques. Characteristics of the protection layer 506 can include one or more of those characteristics described above for the deposited material 122.

FIG. 5B illustrates an example of a lithium metal-free anode 550 according to at least one embodiment of the present disclosure. The lithium metal-free anode 550 includes a coating 554 (or, structure) disposed over at least a portion of a substrate 552. The substrate 552 (for example, substrate 108) can be a current collector, such as a copper web current collector. A thickness of the substrate 552 can be about 2 µm or more and/or about 30 µm or less, such as from about 6 µm to about 20 µm, such as from about 10 µm to about 15 µm, though other thicknesses are contemplated.

The coating 554 can be formed by one or more operations of method 300. The coating 554 can include those materials described herein, for example, Na, K, Rb, Cs, a transition metal, a Group III-Group VI element, oxides thereof, or combinations thereof. In some embodiments, the coating 554 includes Ag, Si, Sn, or combinations thereof.

In some examples, Si or Si-containing materials can be deposited on the current collector (for example, substrate 552) to form a porous or substantially porous silicon-containing coating. Sn and Sn-containing compounds can be deposited on the current collector (for example, substrate 552) to form Sn-containing coatings. Such a tin-containing coating can be an alternative to silicon anodes. Other coatings, such as electrochemical corrosion barriers, direct contact pre-lithiation donor coatings, or other functional coatings are contemplated.

The coating 554 can have a thickness of about 10 µm to about 100 µm, such as from about 15 µm to about 25 µm or such as from about 50 µm to about 100 µm, though a larger or smaller thickness of the coating 554 is contemplated. Other characteristics of the coating 554 can include those characteristics described above for the deposited material 122, such as edge transition (thickness progression), Ra value, Rz value, and density. Methods for controlling edges and other characteristics of the coatings can be performed as described with, for example, method 300.

Overall, embodiments described herein enable deposition of structures on electrodes. Apparatus and methods described herein can be utilized to deposit a wide variety of materials on, for example, LIB anodes and other substrates. Apparatus and methods described herein can also be utilized for forming, for example, pre-lithiation lithium reservoirs, lithium reservoirs, and lithium metal-free reservoirs.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, for example, the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited. As used herein, the terms “approximately” or “about” refer to being within at least ±5% of the reference value.

As used herein, the indefinite article “a” or “an” shall mean “at least one” unless specified to the contrary or the context clearly indicates otherwise. For example, aspects comprising “nanotube” include aspects comprising one, two, or more nanotubes, unless specified to the contrary or the context clearly indicates only one nanotube is included.

As used herein, the terms “inner” and “outer”; “up” and “down”; “upper” and “lower”; “top” and “bottom”, “vertical” and “horizontal”, “upward” and “downward”; “above” and “below”; and other like terms as used herein refer to relative positions to one another and are not intended to denote a particular direction or spatial orientation of the overall source/apparatus.

While the foregoing is directed to embodiments of the present disclosure, other and further embodiments of the disclosure may be devised without departing from the basic scope thereof.

What is claimed is:

1. A method of depositing a structure on a lithium ion battery (LIB) anode, the method comprising:
accelerating particles in a working gas through a convergent-divergent nozzle to a process velocity that is from about a critical velocity of the particles to an erosion velocity of the LIB anode, the particles having a diameter of about 0.5 µm to about 50 µm, the particles comprising an alkali metal, a transition metal, a Group III element, a Group IV element, a Group V element, a Group VI element, or combinations thereof;
heating or cooling the particles in the working gas at a softening temperature concurrent with accelerating the particles;
ejecting the particles in the working gas from a nozzle outlet of the convergent-divergent nozzle, the particles ejected at the process velocity, wherein at least a portion of the particles are in solid phase when ejected from the convergent-divergent nozzle; and
depositing a first structure on the LIB anode, the first structure comprising the alkali metal, the transition metal, the Group III element, the Group IV element, the Group V element, the Group VI element, or the combinations thereof.

2. The method of claim 1, further comprising repeating the accelerating, heating or cooling, and ejecting operations to deposit a second structure over at least a portion of the first structure, the second structure and the first structure comprising a different element of the periodic table of the elements.

3. The method of claim 1, wherein substantially all of the particles ejected from the nozzle outlet are in the solid phase.

4. The method of claim 1, wherein, prior to accelerating the particles in the working gas, the method further comprises:
introducing a flow of the working gas from a working gas inlet into a nozzle flow path of the convergent-divergent nozzle; and
introducing the particles entrained in a carrier gas stream through a particle inlet into the flow of the working gas, the particle inlet located between the working gas inlet and a nozzle inlet of the convergent-divergent nozzle.

5. The method of claim 1, wherein the LIB anode is oriented vertically in free-span or supported on a moveable substrate support.

6. The method of claim 5, further comprising:
moving the LIB anode relative to the convergent-divergent nozzle during depositing the first structure when the LIB anode is supported on the moveable substrate support;
moving the convergent-divergent nozzle relative to the LIB anode; or
combinations thereof.

7. The method of claim 1, wherein the first structure has:
a thickness of about 0.5 µm to about 30 µm ;
an edge transition of about 3 mm or less; or
combinations thereof.

8. The method of claim 1, wherein a mask is patterned on the anode prior to depositing the structure.

9. The method of claim 1, wherein:
the LIB anode comprises graphite or an alloy comprising a Group IV element;
the particles comprise Li, Na, Fe, Cu, Ag, Zn, Si, Ge, Sn, Bi, or combinations thereof; or
combinations thereof.

10. The method of claim 1, wherein the working gas comprises argon.

11. A method of forming a solid metal anode, comprising:
introducing a flow of heated working gas from a working gas inlet into a nozzle flow path of a convergent-divergent nozzle;
injecting particles entrained in a carrier gas through a particle inlet into the flow of heated working gas, the particle inlet located between the working gas inlet and a nozzle inlet of the convergent-divergent nozzle, wherein:
the particles have a diameter of about 0.5 µm to about 50 µm; and
the particles comprise an alkali metal, a transition metal, a Group III element, a Group IV element, a Group V element, a Group VI element, or combinations thereof;
accelerating the particles in the flow of heated working gas through the convergent-divergent nozzle to a process velocity that is from about a critical velocity of the particles to an erosion velocity of a copper substrate of the solid metal anode;
ejecting the particles in the flow of heated working gas from a nozzle outlet of the convergent-divergent nozzle, the particles ejected at the process velocity, substantially all of the particles being in solid phase when ejected from the nozzle outlet; and
depositing a first structure on the copper substrate to form the solid metal anode, the first structure comprising the alkali metal, the transition metal, the Group III element, the Group IV element, the Group V element, the Group VI element, or the combinations thereof.

12. The method of claim 11, wherein the first structure is free of lithium.

13. The method of claim 11, wherein the first structure comprises Ag, Si, Sn, or combinations thereof.

14. The method of claim 11, wherein the first structure has:
a thickness of about 0.5 µm to about 30 µm ;
an edge transition of about 3 mm or less; or
combinations thereof.

15. The method of claim 11, further comprising repeating the introducing, injecting, accelerating, and ejecting operations to deposit a second structure over at least a portion of the first structure, the second structure comprising a different element of the periodic table of the elements than the first structure.

16. The method of claim 15, wherein the second structure comprises Ag, Cu, Au, Zn or, combinations thereof.

17. The method of claim 15, wherein:
the first structure comprises Li, Na, K, or combinations thereof;
the first structure has a thickness of about 0.5 µm to about 30 µm ;
the second structure has a thickness of about 50 µm to about 200 µm; or
combinations thereof.

18. A method of forming an alkali metal-containing structure on an anode, comprising:
heating a working gas to a temperature near or below a melting point of an alkali metal;
introducing a flow of heated working gas from a working gas inlet into a nozzle flow path of a convergent-divergent nozzle;
injecting alkali metal-containing particles entrained in a carrier gas through a particle inlet into the flow of heated working gas, the particle inlet located between the working gas inlet and a nozzle inlet of the convergent-divergent nozzle, the alkali metal-containing particles having a diameter of less than about 50 µm ;
accelerating the alkali metal-containing particles in the flow of heated working gas through the convergent-divergent nozzle to a process velocity that is from about a critical velocity of the alkali metal-containing particles to an erosion velocity of the anode;
heating the alkali metal-containing particles in the flow of heated working gas at a softening temperature concurrent with accelerating the alkali metal-containing particles;
ejecting the alkali metal-containing particles in the flow of heated working gas from a nozzle outlet of the convergent-divergent nozzle, the alkali metal-containing particles ejected at the process velocity, at least a portion of the alkali metal-containing particles being in solid phase when ejected from the convergent-divergent nozzle; and
depositing the alkali metal-containing structure on the anode, the alkali metal-containing structure having a thickness of about 0.5 µm to about 30 µm.

19. The method of claim 18, wherein the alkali metal comprises Li or Na.

20. The method of claim 18, wherein the working gas comprises argon.
